(19) United States
(12) Patent Application Publication
(10) Pub. No.: US 2015/0142525 A1
(43) Pub. Date: May 21, 2015

(54) ATTACHABLE CONTINGENT SERVICE PRICING

(71) Applicant: Hewlett-Packard DeveIopment Company, L. P., Houston, TX (US)

(72) Inventors: Filippo Balestrieri, Mountain View, CA (US); Christina Aperjis, Takoma Park, MD (US)

(73) Assignee: Hewlett-Packard DeveIopment Company, L. P., Houston, TX (US)

(21) Appl. No.: 14/086,186

(22) Filed: Nov. 21, 2013

(51) Int. Cl. G06Q 30/02

(52) U.S. Cl. CPC G06Q 30/0206
USPC 705/7.35

(57) ABSTRACT

Systems and methods associated with attachable contingent service (ACS) pricing are disclosed. One example method includes collecting data describing a replacement propensity for a product. The method also includes estimating expenses for providing an ACS for the product based on the replacement propensity. The method also includes estimating a consumer's expected willingness to pay for the ACS based on the replacement propensity. The method also includes offering to provide the ACS to a consumer who purchases the product. The ACS is offered at a price generated based on the expenses for providing the ACS and the consumer's expected willingness to pay for the ACS.

### BACKGROUND

Many products are sold in conjunction with services such as warranties and service plans. In some cases, the cost of providing the services may be factored into the price of the product. Typically, this ensures that the consumer may have the product replaced or repaired if a defect with the product is identified early in the product's lifetime. In other instances, the warranty may be offered to the consumer at an extra cost. These may extend the warranty for the product so that the consumer does not have to pay out of pocket to replace or repair the product if it breaks at a later point in its life cycle.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example data and an example process for pricing an attachable contingent service;

FIG. 2 illustrates a flowchart of example operations associated with pricing an attachable contingent service;

FIG. 3 illustrates another flowchart of example operations associated with pricing an attachable contingent service;

FIG. 4 illustrates an example system that can be used to price and offer for sale an attachable contingent service; and

FIG. 5 illustrates an example computing environment in which example systems and methods, and equivalents, may operate.

### DETAILED DESCRIPTION

Systems and methods associated with pricing an attachable contingent service (ACS) are described. As used herein, a service is considered attachable if it is typically sold to a consumer in relation to a consumer's purchase of a specific product, primary good, or service. Though the sale of an attachable service typically occurs at substantially the same time as the sale of the product, it is possible that the sale of the ACS will occur at a later point in time. For example, an extended service plan for an automobile may be offered to a consumer upon or near the expiration of a standard warranty that came with the automobile.

As used herein, a service is contingent if the service will be provided after the occurrence of a pre-specified event that may or may not occur in the future. Thus, an ACS is typically purchased at the same time as a product to reduce the financial burden of the product over time due to, for example, future events that may adversely affect the performance of the product. Example ACS's include insurance policies, extended warranties, upgrade programs, and service plans. A one-time ad-hoc service that is obtained when needed (e.g., repairs purchased after a product has become damaged) would typically not be considered an ACS. ACS's may be purchased, for example, in conjunction with electronic devices (e.g., personal computer, printer), appliances (e.g., refrigerator, washing machine), vehicles, industrial machinery, and so forth.

In various examples, an ACS for a product is priced by considering a replacement propensity for the product in addition to behavioral analysis based on the utility of the product to the consumer. A replacement propensity for a product may describe a probability that a consumer will replace the product at various points in time. Data is collected from consumers to estimate replacement propensities for a product and extract the consumers' behavior and attitudes toward the product. Consumers may have different replacement propensities depending on whether they purchased the ACS. For example, a consumer who purchases a warranty may be willing to keep the product for a longer period of time. The ACS for the product is offered to consumers based on a consumer's expected willingness to pay for the ACS and expenses for providing the ACS based on the replacement propensity.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

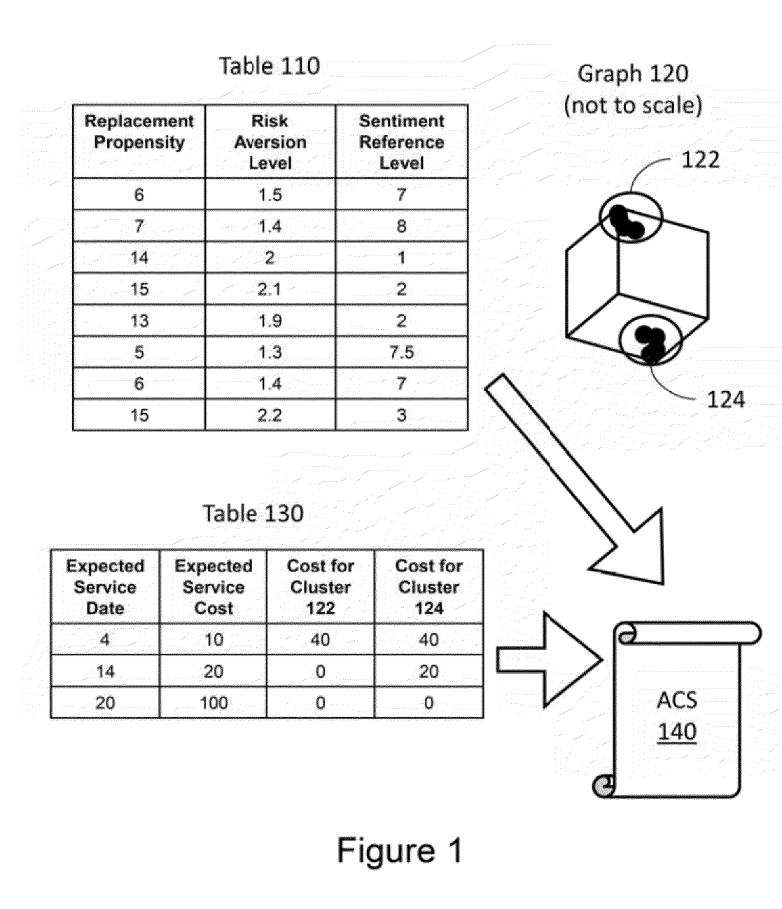

Example procedures for pricing an attachable contingent service (ACS) are illustrated with reference to FIG. 1. A consumer desires to purchase a product, a service, or a primary good that may benefit from having an ACS associated with it. For example, the product may be an expensive product (e.g., an automobile, electronic appliances such as TVs, computers, video games, and cameras, home appliances such as refrigerators, water heaters, and so on) or be difficult to repair. The product may be purchased online or at a brick-and-mortar store. In a market where buyers differ in terms of when they replace the product (e.g., some buyers may use an appliance for 3 years, whereas others may use it for 5 years), the cost of providing long-term attachable contingent services differs across buyers. Given that, a seller or service provider may be interested in differentiating across potential buyers.

The seller of the product may offer an ACS, e.g., ACS 140, associated with the product that is priced based on both the willingness of the consumers to pay for the ACS and the expected cost of providing the ACS for the various segments of the market. ACS 140 may be, for example, a warranty, a service plan, an insurance policy, and so forth. Pricing the ACS may be based on data collected from consumers, such as, for example, data in table 110. The data from table 110 may be collected from a consumer survey, from historical data of prior use of similar products, and/or from other sources. The data may be collected from a representative and unbiased sample of the product market. The data, including replacement propensities, loss aversion coefficients, and sentiment reference levels for different consumers may then be arranged into dusters using statistical techniques that find similarities in the data. Each group may represent a different group of consumers having similar behavior and attitudes toward the product.

In this example, the replacement propensities may indicate how many units of time (e.g., months, years, etc.) specific consumers used a similar product(s) before replacing them, thereby creating a distribution of replacement propensities. The loss aversion coefficient may describe a relative impact of a loss and a gain on a consumer's utility, where the loss and the gain are similarly sized. And the sentiment reference level may quantify a consumer's tolerance towards depreciation of the product. Thus, the sentiment reference level may represent the value of the product to the consumer, sometimes referred to as the utility of the product to the consumer. Each duster may be represented by a joint distribution for the replacement propensity, the degree of loss aversion, and the sentiment level. Clusters may also take other factors (e.g., demographics) into account.

Graph 120 illustrates visually how the data in table 110 may be collected into dusters (e.g., two clusters) based on the similarities in data between the different consumers identified by table 110. Cluster 122 may be associated with the consumers having replacement propensities ranging from five to seven, and cluster 124 may be associated with the consumers having replacement propensities ranging from thirteen to fifteen. It should be appreciated that the example data generated for FIG. 1 was designed so that two clear dusters would be generated. Other data may lead to more dusters that will require differentiation along several dimensions (e.g., replacement propensity, loss aversion coefficient, and sentiment level). Additionally, the number of clusters identified may depend on the clustering method used and/or be constrained by user specifications. Further, a user viewing a visual representation of the data may be able to specify the dusters.

Once dusters of consumers are identified, expected service costs for the dusters may be estimated based on expected service dates and expected service costs. Table 130 indicates how costs for dusters may be calculated. For example, the first row of the table 130 indicates the expected cost (10) of providing a service that occurs with some known probability (based, for example, on prior data) approximately four time units into the life cycle of a product. Here, the cost of providing the service will be 40 for both cluster 122 and duster 124 because each duster contains 4 users and because consumers in both groups are likely to continue to use the product until after the expected service date, based on the replacement propensities in table 110. In contrast, the second row indicates that the expected service cost for duster 122 will be zero because members of the first cluster will likely have replaced the product by the time that service event arises, whereas the cost for duster 124 will be 20 based on the replacement habits of the members of the group. A service event at time 20 will likely not be used by members of either group, and therefore the cost of the service is 0 for both dusters. In this example, it is assumed that the ACS was used by consumers each time a service event arose. However, this may not be the case as some consumers, based on their sentiment level, may opt not to repair the good when damage occurs.

Once the costs for the dusters have been identified, behavioral data, including the loss aversion coefficient and the sentiment reference levels identified in table 110, can be taken into account to determine a price for ACS 140 that users in the clusters are willing to pay. In one example, a unified price for ACS 140 can be determined that will be offered to consumers regardless of their clusters. In another example, where it is possible to identify that a consumer is likely a member of a specific duster (e.g., by age, online shopping history, self-identification, etc.), it may be appropriate to generate different prices for ACS 140 to offer to members of the different dusters.

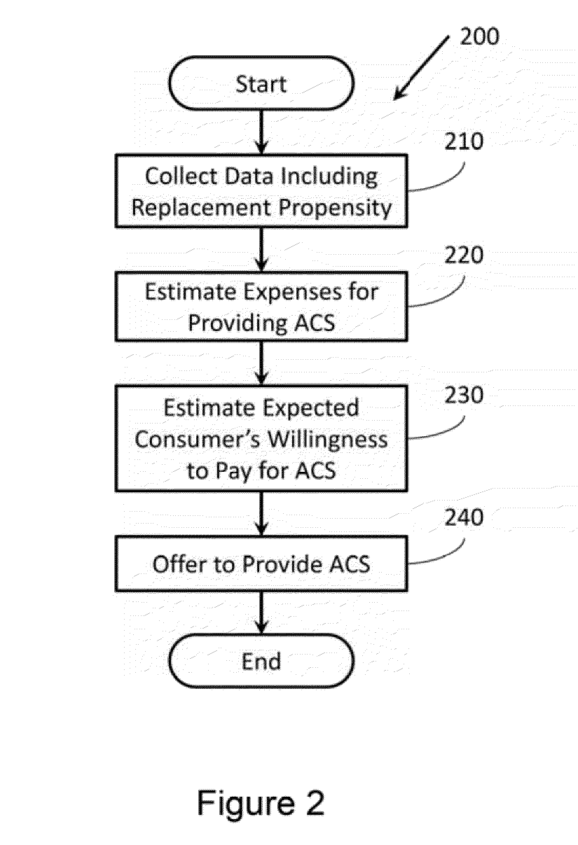

FIG. 2 illustrates an example flowchart of a method 200 associated with pricing an attachable contingent service (ACS). The method 200 may be performed by a computer. Method 200 includes, at 210, collecting data describing a replacement propensity for a product. The replacement propensity may describe a probability that a consumer will replace the product at various points in time. Different products may have different lifetimes. For example, a refrigerator may have a ten year lifetime, whereas a personal computer may have a three year lifetime. Further, different consumers may replace the products at different times during the lifetimes of the products. Some technologically sophisticated consumers may replace their products (e.g., cell phones, computers, appliances, etc.) on a regular basis or when a new model is released regardless of whether their old products have become nonfunctional due to use or damage. Other consumers may continue to use an older model until it breaks or is no longer supported. Thus, replacement propensities for different consumers may vary.

In addition to data describing a replacement propensity, data describing a sentiment reference level, data describing a loss aversion coefficient, and demographic data may also be collected. In one example, the data may be collected at 210 using a consumer survey. In another example, the data may be collected at 210 based on historical information of similar products, prior versions of the current product, and so forth. The sentiment reference level may describe a consumer's tolerance towards depreciation of the product. A sentiment reference level may be obtained by direct inquiries regarding the consumer's satisfaction with the product over the lifetime of the product, or by general lifestyle questions. For example, if a consumer indicates they repair the vehicle regularly and at high cost in response to being asked how frequently they repair their automobile, a high sentiment reference level (i.e., low tolerance for damages) may be inferred. A sentiment reference level may also be determined by examining a price paid for the product, how much less a consumer values the product after the product has been damaged, and so forth.

The loss aversion coefficient may describe a relative impact of a gain and a loss on a consumer's utility. By way of illustration, the loss aversion coefficient may indicate the relative impact on a consumer's utility of a $5 gain instead of a $5 loss. The loss aversion coefficient may be gathered by asking consumers to give preferences between various wagers or gambles.

Method 200 also includes estimating, by a computer, expenses for providing an ACS for the product (220). The expenses may be estimated at 220 based on the replacement propensity. The replacement propensity may indicate, for example, a likelihood that a consumer will replace the product in the middle of a service plan. This may mean that the consumer will not take advantage of service events expected to occur after the consumer has replaced the product. As a result, the expenses for providing the ACS may be adjusted lower because the probability that a service will be provided will be lower than originally anticipated.

Method 200 also includes estimating, by a computer, a consumer's expected willingness to pay for the ACS (230). A consumer's expected willingness to pay for the ACS may describe a maximum price that a consumer is willing to pay for the ACS. Thus, if an ACS is priced above the consumer's expected willingness to pay for the ACS, many consumers will choose not to purchase the ACS. It the ACS is priced below the expected willingness to pay for the ACS, it may be possible to generate more revenues by increasing the price. The consumer's expected willingness to pay may be estimated based on the replacement propensity. By way of illustration, given a loss aversion coefficient and a sentiment reference level, knowing that a consumer is likely to replace the product during the lifetime of the ACS may allow a seller of the ACS to take into account that the consumer is less likely to pay for the ACS because the consumer will not take advantage of the ACS after they have replaced the product covered by the ACS.

Method 200 also includes, at 240, offering to provide the ACS to a consumer who purchases the product. The ACS may be offered at a price generated based on the expenses for providing the ACS and the consumer's expected willingness to pay for the ACS. Knowing the expenses of providing the ACS and the consumer's expected willingness to pay, calculated above at 220 and 230 respectively, may allow better evaluation of an appropriate price at which to offer the ACS. For example, a computer may be able to calculate expected revenues for various prices, and identify a price that maximizes the profits.

In one example, a computer may be configured to offer to provide the ACS to the consumer at 240. This may occur when the consumer purchases the product through an online website, where the consumer is offered the ACS after adding the product to an online shopping cart. In another example, a seller of the product may offer to provide the ACS to the consumer in response to a notification from a computer. This may occur in a retail environment, where a cashier receives a notification to offer the ACS to the consumer after scanning a barcode of the product with which the ACS is associated.

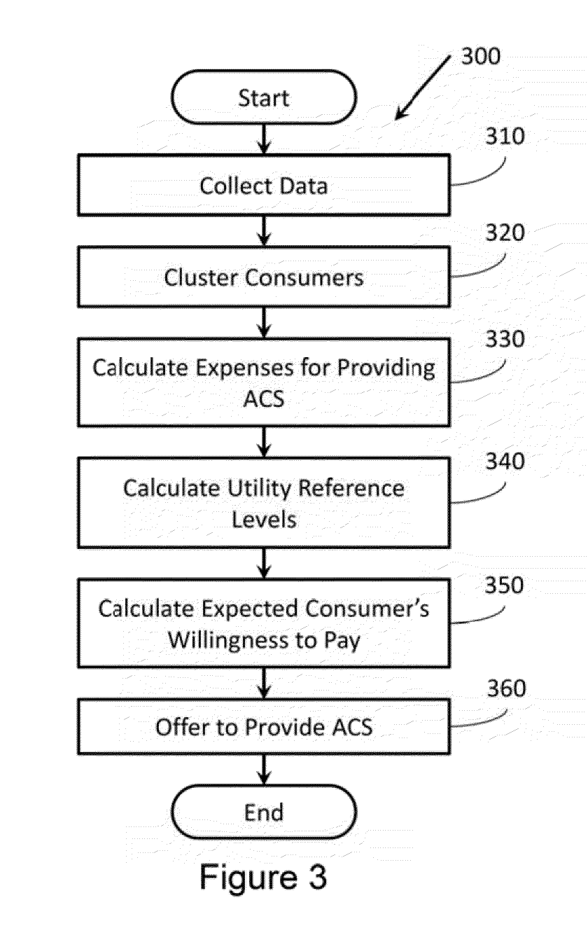

FIG. 3 illustrates an example flowchart of a method, 300, associated with pricing an attachable contingent service (ACS). Method 300 includes, at 310, collecting data describing a replacement propensity, a sentiment reference level, and a loss aversion coefficient. Method 300 also includes, at 320, clustering consumers into groups of consumers based on the replacement propensity, the sentiment reference level, and the loss aversion coefficient. The clustering may also be based on other factors (e.g., demographics). The clustering may be performed using statistical techniques (e.g., cluster analysis) to identify groups of consumers that share similar values for their respective replacement propensities, sentiment reference levels, loss aversion coefficients, and other factors (e.g., demographics). For example, table 110 and graph 110 (see description of FIG. 1, above) illustrate how consumers may be clustered.

Method 300 also includes, at 330, calculating expenses for providing the ACS to consumers in a group (duster) of consumers. The calculation may also take into account a cost of providing the ACS, a likelihood of providing the ACS, and a size of the group of consumers. Therefore, the expenses for providing the ACS to consumers in the group of consumers may indicate an aggregate cost for providing the ACS to the group of consumers. Table 130 (FIG. 1) illustrates an example method for identifying expenses for providing the ACS to two groups of consumers (Clusters 122 and 124). Here, due to differing replacement dates for the two clusters the total expected cost for providing the ACS to cluster 122 is 40 and the total expected cost for providing the ACS to duster 124 is 60.

Method 300 also includes, at 340, calculating utility reference levels for the group of consumers. In one example, utility reference levels both for buying the ACS and for not buying the ACS may be calculated. A utility reference level for buying the ACS may indicate the value to the consumer of purchasing the ACS (e.g., money spent now, but saved later when the ACS covers costs that would have otherwise been expended by the consumer). Similarly a utility reference level for not buying the ACS may indicate the value to the consumer of not purchasing the ACS (e.g., money saved by not purchasing the ACS less future expenditures to cover services that would have been covered by the ACS). Calculating the utility reference levels may take into account the sentiment reference level, a replacement propensity induced by purchasing the ACS, the price of the ACS, and expenses the consumer would incur for purchasing alternative ad-hoc services. Consequently, a high sentiment may indicate that the consumer has high expectations for the product, and will be harmed if the product is damaged. In this case, the consumer's utility for purchasing the ACS may be high because the consumer expects to benefit from the ACS if the product is damaged. Alternatively, a low sentiment may indicate that the consumer has low expectations for the product, believing that there is little value in the ACS. A group with a higher utility reference level from buying may be willing to spend more on an ACS to ensure a product remains functional throughout its life cycle, or until members of the group begin to replace the product.

Method 300 also includes, at 350, calculating the consumer's expected willingness to pay for the ACS. Calculating the willingness to pay may be based on the loss aversion coefficient, and the utility reference levels from buying the ACS and not buying the ACS. As described above, a higher utility reference level from buying the ACS may indicate that a consumer is willing to pay more for an ACS. Similarly, a higher loss aversion coefficient may also indicate an increased willingness to pay. Further, where it is costly for the consumer to obtain the service provided by the ACS without purchasing the ACS, the consumer's willingness to pay may also be high. This may be because a consumer who does not purchase the ACS may have to pay an even higher out of pocket expense for the service if the contingent circumstance comes to fruition and the ACS was not pre-paid for in advance.

In one example, a consumer's willingness to pay for the ACS may represent the maximum price for which the consumer is better off buying the ACS. By comparing the willingness to pay of several consumers in a duster, a willingness to pay for the duster of consumers may be obtained.

By way of illustration, willingness to pay may be computed using an expectation-based loss aversion theory, among other methods. Assuming that a consumer that has the ACS does not incur costs covered by the ACS whether or not probabilistic events covered by the ACS occur, and assuming that a consumer's replacement propensity does not depend on whether the consumer has bought the ACS, a consumer's willingness to pay may be computed using the expectation-based loss aversion theory according to the following formulas.

For a specific consumer, let λ represent the consumer's loss aversion coefficient. From the consumer's replacement propensity and the expected service costs at various service dates, a distribution function F of service costs that the consumer may incur if the consumer does not purchase the ACS, and the mean m of distribution function F may be determined. Using the above information a value z is computed according to Formula 1.

$$z - \frac{λ - 1}{λ + 1} {\int }_{0}^{z} F ( x ) d x = m \qquad Formula 1$$

Next, the consumer's utility reference level from buying the ACS may then be computed based on distribution function F and the consumer's sentiment reference level. From the utility reference level from buying the ACS, the consumer's reference loss level k may be determined. The consumer's reference loss level k is related to the sentiment reference level and corresponds to the amount of disutility (e.g., future expenses, natural depreciation of the product, expected damages) that the consumer expects to incur or is willing to tolerate in the scenario where the consumer does not buy the ACS. If k is less than or equal to z the consumer's willingness to pay is z. Otherwise, if k is greater than z, the consumer's willingness to pay may be computed according to Formula 2.

$$\frac{λ + 1}{2} ( m - \frac{λ - 1}{λ + 1} ( k - {\int }_{0}^{k} F ( x ) d x ) ) \qquad Formula 2$$

Formula 2 may apply regardless of whether F is a discrete or a continuous probability function.

In one example, a set of consumer's expected willingness's to pay for the ACS may be calculated. In this example, members of the set of consumer's expected willingness's to pay may be associated with groups of consumers. Thus, different willingness's to pay may be created for different groups of consumers. This may allow different prices for the ACS to be offered to different consumers, thereby increasing profits. Alternatively, where a unitary price for the ACS is desired, the unitary price may be chosen according to a criterion (e.g., profit maximization) applied to the willingness's to pay of the various clusters and the costs of service provisions, and then weighted by the sizes of the various clusters.

Method 300 also includes, at 360, offering to provide the ACS to a consumer who purchases the product. Offering to provide the ACS at 360 may include identifying a group with which the consumer is associated. Offering to provide the ACS at 360 may also include offering to provide the ACS to the consumer at a price generated based on the expenses of providing the ACS, and based on a consumer's expected willingness to pay for the ACS that is associated with the group with which the consumer is associated. As described above, if a consumer can be associated with a group (e.g., by age, gender, online shopping history, self-identification, a combination of factors, etc.) the consumer may be offered the ACS at a price generated from that group's consumer's expected willingness to pay. This may facilitate increased profits for the provider of the ACS in addition to better service available to individual consumers.

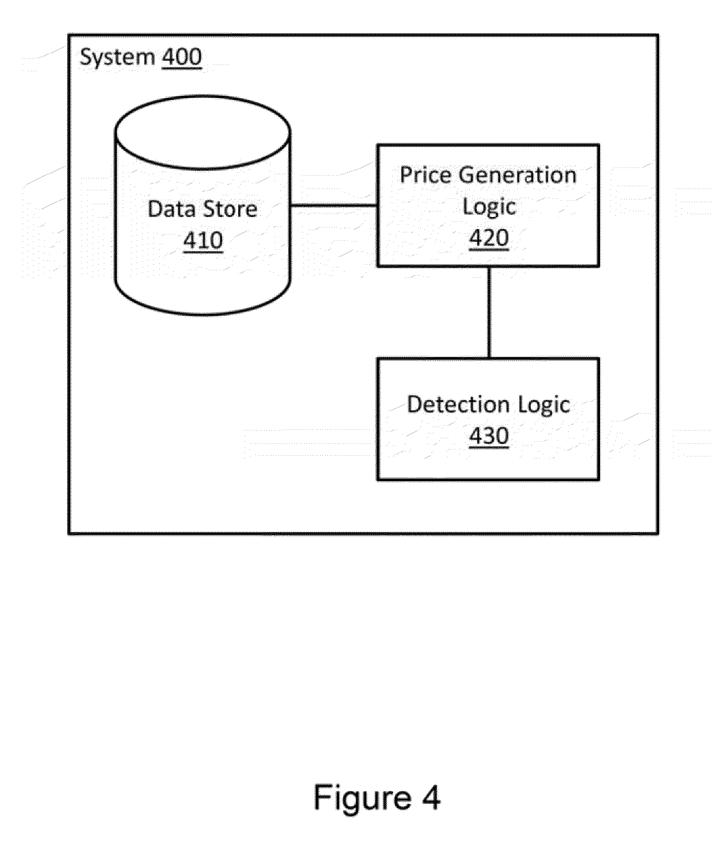

FIG. 4 illustrates an example system 400 that can be used to price and offer for sale an attachable contingent service (ACS). System 400 includes a data store 410. Data store 410 may store data associated with an ACS for a base product. The data may include a replacement propensity. The replacement propensity may describe a likelihood that a consumer will replace the base product at various points in time. In one example, replacement propensities for consumers who have purchased the ACS and for consumers who have not purchased the ACS may be stored. The data may also include service provision costs associated with the ACS, service provision probabilities associated with the ACS, a loss aversion coefficient, and a sentiment reference level. The sentiment reference level may describe a consumer's tolerance towards depreciation of the product, and the loss aversion coefficient may describe a relative impact of a loss and a gain on a consumer's utility, the gain and loss being similarly sized.

In one example, the data associated with the ACS may include sets of behavior data associated with individual consumers. Individual members of the sets of behavior data may include a replacement propensity, a loss aversion coefficient, and a sentiment reference level. Therefore, individual consumers may be associated with a replacement propensity, a loss aversion coefficient, and a sentiment reference level. This may facilitate grouping individual consumers into groups and identifying trends of replacement of the base product.

System 400 also includes a price generation logic 420. Price generation logic 420 may generate a price for the ACS as a function of the replacement propensity. Price generation logic 420 may also generate the price for the ACS as a function of service provision costs, the service provision probabilities, costs to consumers of alternative services, propensities for using the alternative services, the loss aversion coefficient, and the sentiment reference level. Price generation logic 420 may generate the price by clustering members of the set of behavior data into groups. The clustering may be performed according to replacement propensities, loss aversion coefficients, and sentiment reference levels associated with the groups' members. Generating the price may also include calculating service provision costs for providing the ACS to the groups. Price generation logic 420 may take replacement propensities of members of the groups, service provision costs, and service provision probabilities into account when calculating service provision costs.

Price generation logic 420 may also calculate service provision utility values for the groups as a part of generating the price for the ACS. Service provision utility values may be generated based on the service provision costs, and sentiment reference levels of members of the groups. Price generation logic 420 may also calculate expected willingness's to pay for the groups. Calculating an expected willingness to pay may take into account the service provision utility values, loss aversion coefficients of members of the groups, the costs to consumers of alternative services, and propensities for using the alternative services. Expected revenues for various prices for the ACS may also be calculated by price generation logic 420. The expected revenues may be calculated as a function of the expected willingness's to pay for the groups, the service provision costs, and sizes of the groups. Price generation logic 420 may also select a price for the ACS based on the expected revenues. In one example, several prices may be selected and the several prices may be associated with the groups.

System 400 also includes a detection logic 430. Detection logic 430 may detect a sale of the base product. In response to detecting the sale, detection logic 430 may offer to provide the ACS at the price generated by the price generation logic. In an example where price generation logic 420 generates several prices associated with different groups, the detection logic 430 may select a price associated with a group with which a person purchasing the base product is associated.

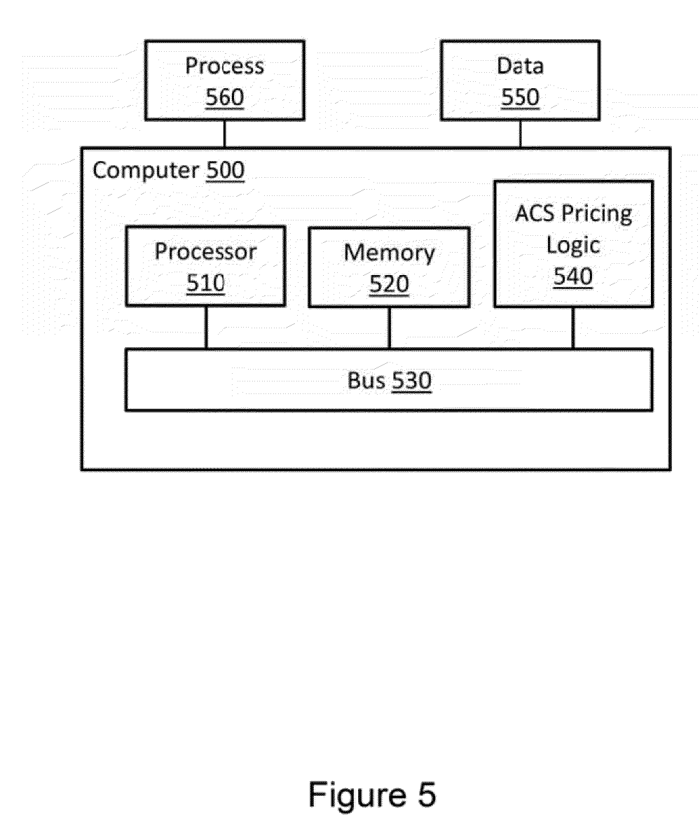

FIG. 5 illustrates an example computing environment in which example systems and methods, and equivalents, may operate. The example computing device may be a computer 500 that includes a processor 510 and a memory 520 connected by a bus 530. The computer 500 includes an attachable contingent service (ACS) pricing logic 540. In different examples, the ACS pricing logic 540 may be implemented as a non-transitory computer-readable medium storing computer-executable instructions in hardware, software, firmware, an application specific integrated circuit, and/or combinations thereof.

The instructions, when executed by a computer, may cause the computer to organize consumers into groups based on replacement propensities. As detailed above, clustering techniques may be used to organize consumers into groups. In one example, consumers may also be organized into groups based on loss aversion coefficients, sentiment reference levels, and demographic data. The instructions may also cause a computer to estimate expenses for providing an ACS for a base product to a group. The expenses may be estimated by multiplying a cost of providing the ACS by a probability of providing the ACS. The probability of providing the ACS may be adjusted based on a replacement propensity of a member of the group.

The instructions may also cause the computer to estimate a utility value for the ACS for members of the group based on the expenses of providing the ACS to the group. The utility value for the group may be estimated based on a sentiment reference level of a member of the group. The utility value for the group may also be estimated based on a loss aversion coefficient of a member of the group. The instructions may also cause the computer to estimate a willingness to pay for the ACS for members of the group based on the utility value. The willingness to pay may be estimated based on costs to consumers of alternative services and propensities for using the alternative services. The instructions may also cause the computer to store expected revenues for various prices for providing the ACS to the group based on the willingness to pay. The expected revenues may be stored based also on the expenses for providing the ACS, and a size of the group. The instructions may also cause the computer to offer the ACS to a consumer who purchase the base product at a price selected to maximize profits.

The instructions may also be presented to computer 500 as data 550 that are temporarily stored in memory 520 and then executed by processor 510. The processor 510 may be a variety of various processors including dual microprocessor and other multi-processor architectures. Memory 520 may include volatile memory (e.g., read only memory) and/or non-volatile memory (e.g., random access memory). Memory 520 may also be, for example, a magnetic disk drive, a solid state disk drive, a floppy disk drive, a tape drive, a flash memory card, an optical disk, and so on. Thus, Memory 520 may store process 560 and/or data 550. Computer 500 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A computer-implemented method for pricing an attachable contingent service, comprising:
collecting data describing a replacement propensity for a product;
estimating, by a computer, expenses for providing an attachable contingent service (ACS) for the product based on the replacement propensity;
estimating, by a computer, a consumer's expected willingness to pay for the ACS based on the replacement propensity; and
offering to provide the ACS to a consumer who purchases the product, where the ACS is offered at a price generated based on the expenses for providing the ACS and the consumer's expected willingness to pay for the ACS.

2. The computer-implemented method of claim 1, where the replacement propensity describes a probability that a consumer will replace the product at various points in time.

3. The computer-implemented method of claim 1, comprising collecting data describing a sentiment reference level, data describing a loss aversion coefficient, and demographic data.

4. The computer-implemented method of claim 3, where the data describing the replacement propensity, the data describing the sentiment reference level, the data describing the loss aversion coefficient, and the demographic data are collected based on a result of a consumer survey.

5. The computer-implemented method of claim 3, where the sentiment reference level describes a consumer's tolerance towards depreciation of the product, and where the loss aversion coefficient describes a relative impact of a loss and a gain on a consumer's utility, where the loss and the gain are similarly sized.

6. The computer-implemented method of claim 1, where the consumer's expected willingness to pay for the ACS describes a maximum price that the consumer is willing to pay for the ACS.

7. The computer-implemented method of claim 3, where estimating the expenses for providing the ACS comprises:
clustering consumers into groups of consumers based on the replacement propensity, the sentiment reference level, the loss aversion coefficient, and demographic data; and
calculating the expenses for providing the ACS to consumers in a group of consumers based on a cost of providing the ACS, a likelihood of providing the ACS, and a size of the group of consumers.

8. The computer-implemented method of claim 7, where estimating the consumer's expected willingness to pay for the ACS comprises:
calculating utility reference levels for the group of consumers based on the sentiment reference level, costs to consumers of alternative services, and propensities for using the alternative services; and
calculating the consumer's expected willingness to pay for the ACS based on the loss aversion coefficient, the expenses for providing the ACS, and the utility reference levels.

9. The computer-implemented method of claim 8, where estimating the consumer's expected willingness to pay for the ACS comprises estimating a set of consumer's expected willingness's to pay for the ACS, where a member of the set of consumer's expected willingness's to pay is associated with the group of consumers.

10. The computer-implemented method of claim 9, where offering to provide the ACS to the consumer who purchases the product comprises:
identifying a group with which the consumer is associated; and
offering to provide the ACS to the consumer at a price generated based on the expenses of providing the ACS and based on a consumer's expected willingness to pay for the ACS associated with the group with which the consumer is associated.

11. The computer implemented method of claim 1, where offering to provide the ACS to the consumer is performed by one of a computer, and a seller of the product in response to a notification from a computer.

12. A system for pricing an attachable contingent service, comprising:
a data store to store data associated with an attachable contingent service (ACS) for a base product, the data comprising a replacement propensity;
a price generation logic to generate a price for the ACS as a function of the replacement propensity; and
a detection logic to, in response to detecting a sale of the base product, offering to provide the ACS at a price generated by the price generation logic.

13. The system of claim 12, where the data associated with the ACS further comprises service provision costs associated with the ACS, service provision probabilities associated with the ACS, a loss aversion coefficient, and a sentiment reference level, and where the price generation logic generates the price for the ACS as a function of the service provision costs, the service provision probabilities, the loss aversion coefficient, and the sentiment reference level.

14. The system of claim 13, where the replacement propensity describes a likelihood that a consumer will replace the base product at various points in time, where the sentiment reference level describes a consumer's tolerance towards depreciation of the product, and where the loss aversion coefficient describes a relative impact of a loss and a gain on a consumer's utility, where the loss and the gain are similarly sized.

15. The system of claim 13, where data associated with the ACS comprises demographic data and sets of behavior data associated with consumers, where members of the sets of behavior data comprise a replacement propensity, a loss aversion coefficient, and a sentiment reference level.

16. The system of claim 15, where the price generation logic generates the price for the ACS by:
clustering members of the sets of behavior data into groups according to replacement propensities, loss aversion coefficients, sentiment reference levels associated with the members, and demographic data;
calculating service provision costs for providing the ACS to the groups as a function of replacement propensities of members of the groups, the service provision costs, and the service provision probabilities;
calculating service provision utility values for the groups as a function of the sentiment reference levels of members of the groups, and loss aversion coefficients of members of the groups;
calculating expected willingness's to pay for the groups as a function of the service provision utility values, and service provision costs to consumers of alternative services, and propensities for using the alternative services;
calculating expected revenues for various prices for the ACS as a function of the expected willingness's to pay of the groups, the service provision costs, and sizes of the groups; and
selecting a price for the ACS as a function of the expected revenues.

17. The system of claim 16, where selecting a price for the ACS as a function of the expected revenues includes selecting several prices and associating the prices with the groups, and where offering to provide the ACS comprises selecting a price associated with a group with which a person purchasing the base product is associated.

18. A non-transitory computer-readable medium storing computer-executable instructions that when executed by a computer cause the computer to:
organize consumers into groups based on replacement propensities;
estimate expenses for providing an attachable contingent service (ACS) for a base product to a group by multiplying a cost of providing the ACS by a probability of providing the ACS, the probability adjusted based on a replacement propensity of a member of the group;
estimate a utility value for the ACS for members of the group;
estimate a willingness to pay for the ACS for members of the group based on the utility value; and
store expected revenues for various prices for providing the ACS to the group based on the willingness to pay.

19. The non-transitory computer-readable medium of claim 18, where the computer executable-instructions also cause the computer to:
offer the ACS to a consumer who purchases the base product at a price selected to maximize profits.

20. The non-transitory computer-readable medium of claim 18,
where consumers are organized into groups based on loss aversion coefficients and sentiment reference levels,
where the utility value for the group is estimated based on a sentiment reference level of a member of the group,
where the willingness to pay for the ACS is estimated based on a loss aversion coefficient of a member of the group and the expenses of providing the ACS to the group, and
where the expected revenues are stored based on the expenses for providing the ACS, and a size of the group.
